(19) United States
(12) Patent Application Publication
(10) Pub. No.: US 2018/0147702 A1
(43) Pub. Date: May 31, 2018

(54) MOVABLE WRENCHING TOOL

(71) Applicant: Yi-Feng LIU, New Taipei (TW)

(72) Inventor: Yi-Feng LIU, New Taipei (TW)

(21) Appl. No.: 15/364,907

(22) Filed: Nov. 30, 2016

(51) Int. Cl. B25B 23/00; B25B 15/00; B25B 15/02

(52) U.S. Cl. CPC B25B 23/0028; B25B 15/02; B25B 15/008

(57) ABSTRACT

A movable wrenching tool comprises a bend shaft and a long shaft connected to the bend shaft. The bend shaft includes a first working portion extending in a first direction, a short shaft portion extending in a second direction, and a rotating portion connected to the short shaft portion. The rotating portion comprises first and second side walls extending in the second direction and being provided in parallel with each other. A position limiting notch is formed between the first and second side walls. In this case, the first direction and the second direction are different from each other. The long shaft comprises a projecting portion butted against the rotating portion, such that the projecting portion of the long shaft is inserted into the position limiting notch of the rotating portion, so as to enable the rotation of the long shaft with respect to the bend shaft.

### FIELD OF THE INVENTION

The present invention is related to a wrenching tool, particularly to a folding L-shaped two-section or folding Z-shaped three-section movable wrenching tool.

### BACKGROUND OF THE INVENTION

Bolts and nuts are commonly used fastening elements, widely applied to machines, electrical appliances and buildings, even to furniture and etc., for assembling two parts to create a convenient living of modern people. For facilitating a user to turn the fastening elements, such as bolts and nuts, easily, wrenches become indispensable tools in living. With the progress of the times, moreover, bolts and nuts of various patterns are derived in response to the changing times, and lead to a tendency toward the diversity of wrenching tools.

Utility and convenience are always two major considerations for work in living. Parts of industry insiders look forward to more labor-saving and more ergonomic tools to be published, so as to invest in improvement and research & development on the structure of wrenching tools actively, apart from devoting themselves to improvement on specifications and patterns of the wrenching tools in correspondence to various bolts and nuts.

For instance, in a hexagonal wrench holding-sheath structure disclosed in Taiwan utility model patent no. M341584, a folding hexagonal wrench comprises a shorter vertical working portion and a longer horizontal holding and force-applying portion. Moreover, a holding-sheath is plastically injected to be combined onto the holding and force-applying portion directly, such that a hexagonal propping portion matched with the holding and force-applying portion in shape is constructed, while a round thickening portion is then constructed at the rear section. On the round thickening portion, texture is formed, and thereby the coefficient of surface friction is increased.

The above is designed, however, primarily for easy grasping for the user. Further research and development on how to fastening bolts and nuts through wrenching tools in a labor-saving and rapid manner is still needed.

### SUMMARY OF THE INVENTION

It is the main object of the present invention to disclose a movable wrenching tool, capable of being folded into various patterns for manipulation depending upon the conditions of use, such that the effect of fastening bolts and nuts is achieved in a labor-saving and rapid manner.

For achieving the above object, the movable wrenching tool of the present invention comprises a bend shaft and a long shaft connected to the bend shaft.

In this case, the bend shaft includes a first working portion extending in a first direction, a short shaft portion extending in a second direction, and a rotating portion connected to the short shaft portion. The rotating portion comprises a first side wall and a second side wall extending in the second direction and being provided in parallel with each other. A position limiting notch is formed between the first side wall and the second side wall. Moreover, the first direction and the second direction are different from each other.

As for the long shaft connected to the bend shaft, the long shaft comprises a projecting portion butted against the rotating portion, such that the projecting portion of the long shaft is inserted into the position limiting notch of the rotating portion, so as to enable the rotation of the long shaft with respect to the bend shaft.

It is easy for the movable wrenching tool of the present invention to switch between the pattern of folding L-shaped two-section and that of folding Z-shaped three-section as required due to the design of the rotating portion. The most efficient mode may be selected for manipulation by the user. Therefore, the merit of fastening bolts and nuts labor-savingly and rapidly is possessed.

### BRIEF DESCRIPTION OF THE DRAWINGS

FIG. 1A is a schematic external view of a first embodiment of the present invention.

FIG. 1B is a schematic external view of a second embodiment of the present invention.

FIG. 2 is an exploded view of the second embodiment of the present invention.

FIG. 3 is a schematic external view of another pattern of the second embodiment of the present invention.

FIGS. 4A to 4C are schematic views showing the implement of the second embodiment of the present invention.

### DETAILED DESCRIPTION OF THE PREFERRED EMBODIMENTS

For further understanding the structure, features and effects, the present invention will be described in detail with respect to the preferred embodiments in conjunction with the drawings as follows.

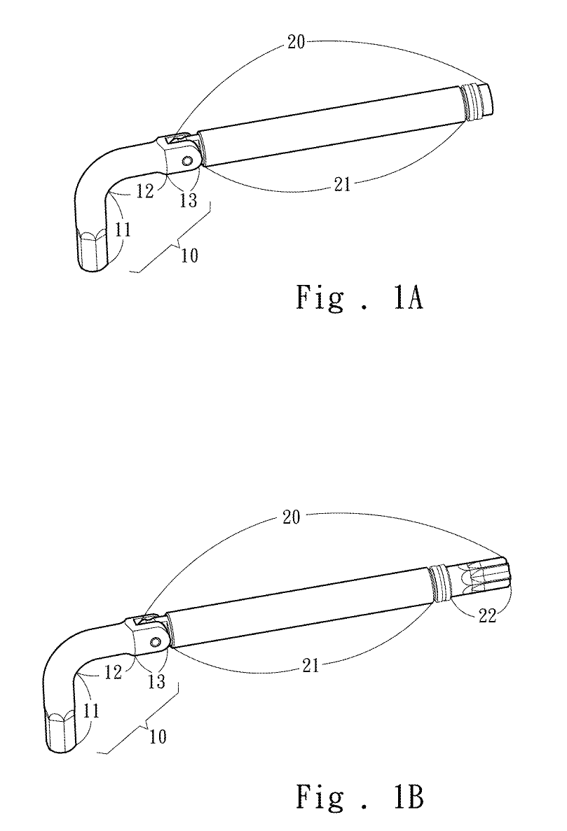

Referring to FIG. 1A firstly, there is shown a schematic external view of a first embodiment of the present invention. In this case, a movable wrenching tool comprises a bend shaft 10 and a long shaft 20 connected to the bend shaft. The bend shaft 10 includes a first working portion 11 extending in a first direction, a short shaft portion 12 extending in a second direction, and a rotating portion 13 connected to the short shaft portion 12. Furthermore, the long shaft 20 comprises a projecting portion (not shown) butted against the rotating portion 13. In this embodiment, the long shaft 20 further comprises a covering tube 21 on a surface thereof. The covering tube 21 is provided with a hollow structure used for accommodating the long shaft 20. Moreover, the covering tube 21 is coveringly attached to the long shaft 20 to be rotatable.

Referring to FIG. 1B, there is shown another second embodiment of the present invention. A movable wrenching tool of the second embodiment is substantially the same as the movable wrenching tool of the first embodiment in terms of structure, with the difference lying in that the long shaft 20, in the second embodiment, further comprises a second working portion 22 provided at one side far away from the bend shaft 10. In this embodiment, the movable wrenching tool may be applied more widely by providing the second working portion 22.

In the present invention, the first working portion 11 and the second working portion 22 may be identical to or different from each other, and each of them is shaped individually as internal minus, external minus, internal plus, external plus, internal square, external square, internal pentagon, external pentagon, internal hexagon, external hexagon or another shape matched with the shape of a fastener, such as a six-lobe shape in the form of a polygon with curved sides, for example, without specific limitation in the present invention.

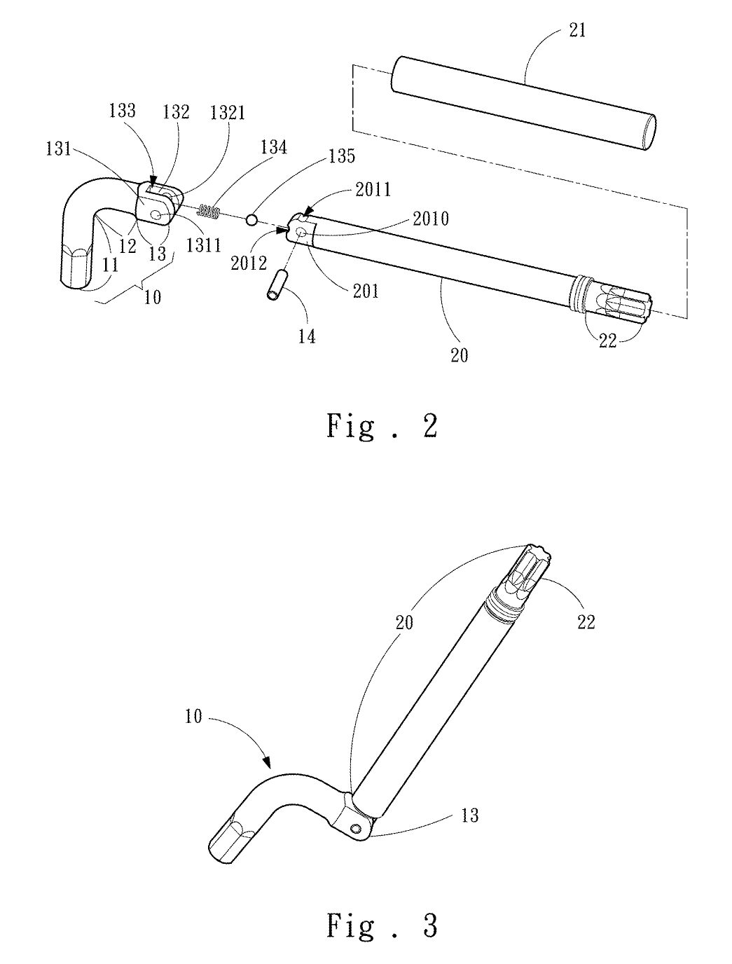

Subsequently, the rotation mechanism and related elements of the movable wrenching tool of the present invention will be introduced further principally via an exploded view of the second embodiment shown in FIG. 2 together with FIG. 1B.

Referring to FIG. 2, a bend shaft 10 of a movable wrenching tool includes a first working portion 11 extending in a first direction, a short shaft portion 12 extending in a second direction, and a rotating portion 13 connected to the short shaft portion 12. The rotating portion 13 comprises a first side wall 131 and a second side wall 132 extending in the second direction and being provided in parallel with each other. A position limiting notch 133 is formed between the first side wall 131 and the second side wall 132.

The above-mentioned first direction and second direction are different from each other. In other words, the first direction and the second direction are not in parallel with each other, while an included angle is presented between these directions. In one preferred embodiment of the present invention, an included angle roughly 90° is provided between the first direction and the second direction. The range of the included angle may be adjusted on the basis of actual conditions, however, without specific limitation in the present invention.

The bend shaft 10 is connected to a long shaft 20, while the long shaft 20 comprises a projecting portion 201 butted against the rotating portion 13, a covering tube 21 coveringly attached to the long shaft 20, and the second working portion 22.

The projecting portion 201 of the long shaft 20 is inserted into the position limiting notch 133 of the rotating portion 13. For facilitating the rotational positioning, the projecting portion 201 may be provided with at least two positioning notches, such as a first positioning notch 2011 and a second positioning notch 2012, for example. An included angle between a first virtual line passing through the center point of the first positioning notch 2011 and a second virtual line passing through the center point of the second positioning notch 2012 is 90°

In this embodiment, the first side wall 131 is provided with a first hole 1311, the second side wall 132 is provided with a second hole 1321, and the projecting portion 201 of the long shaft 20 is also provided with a third hole 2010. When the projecting portion 201 is inserted into the position limiting notch 133 completely, the first hole 1311, the second hole 1321 and the third hole 2010 are superposed (coaxially superposed) one another at the same location. There is a rotation pin 14 inserted into the coaxially superposed first hole 1311, second hole 1321 and third hole 2010 at this time.

In this embodiment, the rotating portion 13 further comprises a spring 134 provided within the position limiting notch 133, and a steel ball 135 provided at one end of the spring 134 and contacted with the spring. In other words, when the long shaft 20 and the bend shaft 10 are connected, the spring 134 and the steel ball 135 are both sandwiched between the position limiting notch 133 of the rotating portion 13 and the projecting portion 201 of the long shaft 20.

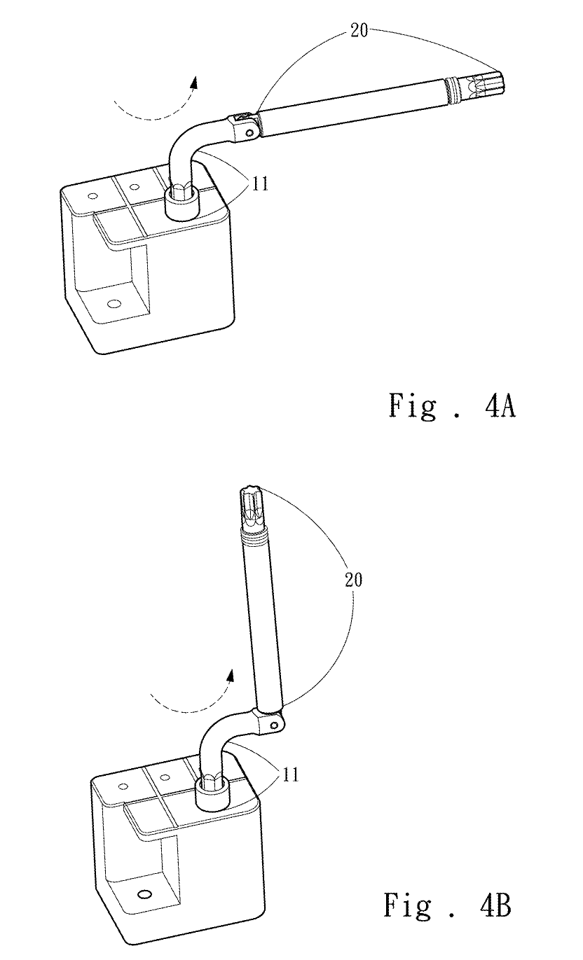

Accordingly, the rotation of the movable wrenching tool of the present invention may be more flexible. The movable wrenching tool may be folded into the pattern of two-section or three-section for manipulation as required by a user. When the movable wrenching tool is folded into the pattern of (L-typed) two-section for manipulation by the user, the spring 134 is abutted at one end thereof against the position limiting notch 133 and contacted at the other end thereof with the steel ball 135 in the rotating portion 13. As far as the steel ball 135 is concerned, it is sandwiched between the spring 134 and the second positioning notch 2012 of the projecting portion 201. At this moment, the extending direction of the long shaft 20 is the second direction, as that of the short shaft portion 12. When the movable wrenching tool is folded into the pattern of (Z-shaped) three-section by the user for manipulation, the spring 134 is abutted at one end thereof against the position limiting notch 133 and contacted at the other end thereof with the steel ball 135 in the rotating portion 13. As far as the steel ball 135 is concerned, it is sandwiched between the spring 134 and the first positioning notch 2011 of the projecting portion 201. At this moment, the extending direction of the long shaft 20 is the first direction, as that of the first working portion 11. The appearance is shown as the schematic view of FIG. 3,

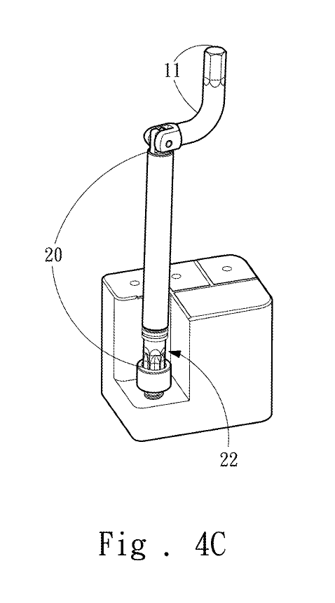

FIGS. 4A to 4C are schematic views showing the implement of the movable wrenching tool of the present invention. FIG. 4A shows the movable wrenching tool of the second embodiment presented in the pattern of (L-shaped) two-section, in which the first working portion 11 is joined to a screw, and the user is then allowed to hold and turn the long shaft 20 so as to loosen and tighten the screw easily. FIG. 4B shows the movable wrenching tool of the second embodiment presented in the pattern of (Z-shaped) three-section, in which the movable wrenching tool is firstly rotated into the pattern of (Z-shaped) three-section via the rotating portion. Similarly, the first working portion 11 is joined to a screw, and the user is then allowed to hold and turn the long shaft 20 to rock rapidly, so as to achieve the object of loosening and tightening the screw rapidly. FIG. 4C shows the movable wrenching tool of the second embodiment in another pattern, in which a screw is joined to the second working portion 22, such that the first working portion 11 is held and turned by the user to equally achieve the effect of loosening and tightening the screw.

As mentioned above, it is possible for the user to vary the pattern of the wrenching tool into the pattern of two-section or three-section for manipulation as required through the design of the rotating portion in the present invention. There are at least two merits, in comparison with the prior art, as follows:

1. Considerable convenience of the design of the rotating portion in terms of manipulation, allowing the user to selectively vary the pattern of the wrenching tool into the pattern of (L-shaped) two-section or the pattern of (Z-shaped) three-section as required, so as to meet requirements owing to various usage environments, and thus achieve the object of loosening/tightening various kinds of fasteners labor-savingly and rapidly.

2. Two working portions designed for the wrenching tool, such that each of the working portions may be joined to the fastener of individual shape, respectively, so as to enhance flexibility and convenience in use.

1. A movable wrenching tool, comprising:
a bend shaft including a first working portion extending in a first direction, a short shaft portion extending in a second direction, and a rotating portion connected to the short shaft portion, the rotating portion comprising a first side wall and a second side wall extending in the second direction and being provided in parallel with each other, a position limiting notch being formed between the first side wall and the second side wall, wherein the first working portion and the short shaft portion defining an included angle which is provided between the first direction and the second direction, and the first direction and the second direction are different from each other; and
a long shaft connected to the bend shaft, the long shaft comprising a projecting portion butted against the rotating portion, such that the projecting portion of the long shaft is inserted into the position limiting notch of the rotating portion, so as to enable the long shaft to rotate the bend shaft relatively,
wherein the long shaft defines a first state providing a pattern of the movable wrenching tool as a folding L-shaped two-section when the long shaft is in the second direction, and a second state providing the pattern of the movable wrenching tool as a folding Z-shaped three-section when the long shaft is opposite to the first direction.

2. The movable wrenching tool according to claim 1, further comprising a covering tube provided with a hollow structure for accommodating the long shaft, such that the covering tube is coveringly attached to a surface of the long shaft.

3. The movable wrenching tool according to claim 1, wherein the first side wall of the position limiting notch is provided with a first hole, the second side wall thereof is provided with a second hole, and the projecting portion of the long shaft is provided with a third hole, such that the first hole, the second hole and the third hole are coaxially superposed when the projecting portion is inserted into the position limiting notch completely.

4. The movable wrenching tool according to claim 3, wherein there is a rotation pin inserted into the first hole, the second hole and the third hole, when the projecting portion is inserted into the position limiting notch completely such that the first hole, the second hole and the third hole are coaxially superposed.

5. The movable wrenching tool according to claim 1, wherein the rotating portion further comprises a spring provided within the position limiting notch, and a steel ball provided at one end of the spring and contacted with the spring, such that the spring and the steel ball are both sandwiched between the position limiting notch of the rotating portion and the projecting portion of the long shaft when the long shaft and the bend shaft are connected.

6. The movable wrenching tool according to claim 5, wherein the projecting portion is provided with at least two positioning notches.

7. The movable wrenching tool according to claim 1, wherein the shape of the first working portion is selected from the group consisting of internal minus, external minus, internal plus, external plus, internal square, external square, internal pentagon, external pentagon, internal hexagon, external hexagon and six-lobe shape.

8. The movable wrenching tool according to claim 1, wherein the long shaft further comprises a second working portion provided at one side far away from the bend shaft.

9. The movable wrenching tool according to claim 8, wherein the shape of the second working portion is selected from the group consisting of internal minus, external minus, internal plus, external plus, internal square, external square, internal pentagon, external pentagon, internal hexagon, external hexagon and six-lobe shape.

10. The movable wrenching tool according to claim 1, wherein an included angle between the first direction and the second direction is 90°.
